(19) United States
(12) Patent Application Publication
(10) Pub. No.: US 2025/0161728 A1
(43) Pub. Date: May 22, 2025

(54) FIRE SUPPRESSION SYSTEM FOR BATTERIES WITH MULTIPLE STAGES

(71) Applicant: Tyco Fire Products LP, Cranston, RI (US)

(72) Inventors: Sean S. Troutt, Stephenson, MI (US); Blake Bomann, Greenville, WI (US); Ben Markovitz, Howard, WI (US); David Strobel, Marinette, WI (US)

(73) Assignee: Tyco Fire Products LP, Cranston, RI (US)

(21) Appl. No.: 18/839,687

(22) PCT Filed: Mar. 23, 2023
(86) PCT No.: PCT/IB2023/052889

§ 371 Date: Aug. 19, 2024

Related U.S. Application Data
(60) Provisional application No. 63/323,630, filed on Mar. 25, 2022.

(51) Int. Cl. A62C 3/07; A62C 3/00; A62C 3/16; A62C 37/44; A62C 99/00; H01M 10/48; H01M 10/613; H01M 50/249

(52) U.S. Cl. CPC A62C 3/07; A62C 3/002; A62C 3/16; A62C 37/44; H01M 10/486; H01M 10/613; H01M 50/249; A62C 99/0027; H01M 2200/10; H01M 2220/20

(57) ABSTRACT

A container system includes a shipping container including multiple battery cells and a fire suppression system. The fire suppression system includes multiple fire suppressant containers and processing circuitry. The fire suppressant containers are each configured to store fire suppressant and discharge the fire suppressant to a coverage area of the shipping container. The processing circuitry is configured to obtain detection data indicating a detection of a thermal event or a fire within the shipping container. The processing circuitry is configured to, in response to the detection of the thermal event or the fire within the shipping container, sequentially activate the fire suppressant containers to provide fire suppression according to multiple stages of fire suppression.

### CROSS-REFERENCE TO RELATED PATENT APPLICATION

This application claims the benefit of and priority to U.S. Provisional Application No. 63/323,630, filed Mar. 25, 2022, the entire disclosure of which is incorporated by reference herein.

### BACKGROUND

The present disclosure relates generally to fire suppression systems. More specifically, the present disclosure relates to fire suppression systems for batteries. Modern battery technologies, such as lithium-ion batteries, are desirable for use in many energy storage applications due to their high energy density. However, the materials used in such batteries can be quite flammable and can produce flammable gases (e.g., when overheating). Once the batteries ignite, the resultant fires can be difficult to suppress due to their high temperatures, and the fires can travel quickly between adjacent battery cells. The cells of the batteries are often contained within a sealed housing, making it difficult for an external source of fire suppressant to reach the cells.

### SUMMARY

One embodiment of the present disclosure is a container system. The container system includes a shipping container including multiple battery cells and a fire suppression system. The fire suppression system includes multiple fire suppressant containers and processing circuitry. The fire suppressant containers are each configured to store fire suppressant and discharge the fire suppressant to a coverage area of the shipping container. The processing circuitry is configured to obtain detection data indicating a detection of a thermal event or a fire within the shipping container. The processing circuitry is configured to, in response to the detection of the thermal event or the fire within the shipping container, sequentially activate the fire suppressant containers to provide fire suppression according to multiple stages of fire suppression.

In some embodiments, the stages of fire suppression each include providing the fire suppressant to a different coverage area. Prior stages of the stages of fire suppression include providing fire suppressant to a smaller coverage area, and following stages of fire suppression include providing fire suppressant to a larger coverage area. One or more of the stages include providing a different type of fire suppressant into the shipping container. In some embodiments, at least one of the stages includes sequentially providing fire suppression to different zones before transitioning to a next of the plurality of stages.

In some embodiments, the shipping container includes multiple packs. Each pack includes multiple subpacks positioned within the pack. Each subpack includes multiple modules positioned within the subpack. Each module includes a subset of the battery cells positioned within the module.

In some embodiments, the stages include least two stages and the fire suppressant containers include at least two fire suppressant containers. In a first stage of fire suppression, a first of the at least two fire suppressant containers is configured to provide fire suppressant into at least one of the modules to suppress a fire at one or more of the battery cells. In a second stage of fire suppression, a second of the at least two fire suppressant containers is configured to provide fire suppressant into at least one of the subpacks to suppress a fire at one or more of the modules. The processing circuitry is configured to activate the second stage of fire suppression in response to determining that the fire or thermal event has spread between modules of at least one of the subpacks after performing the first stage of fire suppression.

In some embodiments, the stages include a third stage of fire suppression and the fire suppressant containers include a third fire suppressant container. In the third stage of fire suppression, the third of the fire suppressant containers is configured to provide fire suppressant into the packs to suppress a fire or thermal event at one or more of the subpacks. The processing circuitry is configured to activate the third stage in response to determining that the fire or thermal event has spread between subpacks of at least one of the packs after performing the second stage of fire suppression.

In some embodiments, the stages include a fourth stage and the fire suppressant containers include a fourth fire suppressant container. In the fourth stage, the fourth of the fire suppressant containers is configured to provide fire suppressant into the shipping container outside of the plurality of packs to suppress a fire or thermal event at one or more of the packs. The processing circuitry is configured to activate the fourth stage in response to determining that the fire or thermal event has spread between packs after performing the third stage of fire suppression.

Another embodiment of the present disclosure is a vehicle. The vehicle includes a pack having multiple battery cells and a fire suppression system. The fire suppression system includes multiple fire suppressant containers, and processing circuitry. Each of the fire suppressant container is configured to store fire suppressant and discharge the fire suppressant to a coverage area of the pack. The processing circuitry is configured to obtain detection data indicating a detection of a thermal event or a fire within the pack. The processing circuitry is configured to, in response to the detection of the thermal event or the fire within the pack, sequentially activate the fire suppressant containers to provide fire suppression according to multiple stages of fire suppression.

In some embodiments, the multiple stages each include providing the fire suppressant to a different coverage area. Prior stages of fire suppression include providing fire suppressant to a smaller coverage area, and following stages of fire suppression comprise providing fire suppressant to a larger coverage area.

In some embodiments, one or more of the stages include providing a different type of fire suppressant into the pack. The pack may include multiple subpacks positioned within the pack. Each subpack includes multiple modules positioned within the subpack. Each module includes multiple battery cells positioned within the module.

In some embodiments, the stages include at least two stages and the fire suppressant containers include at least two fire suppressant containers. In a first stage of fire suppression, a first of the at least two fire suppressant containers is configured to provide fire suppressant into at least one of the modules to suppress a fire at one or more of the battery cells. In a second stage of fire suppression, a second of the at least two fire suppressant containers is configured to provide fire suppressant into at least one of the subpacks to suppress a fire at one or more of the modules. The processing circuitry is configured to activate the second stage of fire suppression in response to determining that the fire or thermal event has spread between modules of at least one of the subpacks after performing the first stage of fire suppression.

In some embodiments, the stages include a third stage and the fire suppressant containers include a third fire suppressant container. In the third stage, the third of the fire suppressant containers is configured to provide fire suppressant into the pack to suppress a fire or thermal event at one or more of the subpacks. The processing circuitry is configured to activate the third stage in response to determining that the fire or thermal event has spread between subpacks of at least one pack after performing the second stage of fire suppression.

In some embodiments, the vehicle is a mining vehicle including multiple tractive elements and an implement assembly. The implement assembly and the tractive elements may be driven by one or more electric motors configured to consume electrical energy from the battery cells of the pack.

Another embodiment of the present disclosure is a container system. The container system include a shipping container including battery cells and a fire suppression system. The fire suppression system includes multiple suppressant containers, and a reserve supply system. Each of the suppressant containers is configured to store fire suppressant and discharge the fire suppressant to a coverage area of the shipping container. The reserve supply suppression system is separate from the fire suppression system. The reserve supply suppression system includes a reserve suppressant container that is configured to be manually activated to discharge a reserve supply of fire suppressant into the shipping container immediately prior to physically opening the shipping container to thereby reduce a likelihood of a fire event occurring in response to physically opening the shipping container.

The container system can further include processing circuitry configured to obtain detection data indicating a detection of a thermal event or a fire within the shipping container. The processing circuitry is configured to, in response to the detection of the thermal event or the fire within the shipping container, sequentially activate the fire suppressant containers to provide fire suppression according to stages of fire suppression.

In some embodiments, the stages each include providing the fire suppressant to a different coverage area. Prior stages of fire suppression include providing fire suppressant to a smaller coverage area, and following stages of fire suppression include providing fire suppressant to a larger coverage area.

In some embodiments, one or more of the stages includes providing a different type of fire suppressant into the shipping container. In some embodiments, the stages include at least two stages and the fire suppressant containers include at least two fire suppressant containers. In a first stage of fire suppression, a first of the at least two fire suppressant containers is configured to provide fire suppressant into at least one of multiple modules to suppress a fire at one or more battery cells. In a second stage, a second of the at least two fire suppressant containers is configured to provide fire suppressant into at least one of a plurality of subpacks to suppress a fire at one or more of the modules. The processing circuitry is configured to activate the second stage in response to determining that the fire or thermal event has spread between modules of at least one of the subpacks after performing the first stage of fire suppression.

In some embodiments, the stages include a third stage and the fire suppressant containers include a third fire suppressant container. In the third stage, the third of the fire suppressant containers is configured to provide fire suppressant into multiple packs to suppress a fire or thermal event at one or more of the plurality of subpacks. In some embodiments, the processing circuitry is configured to activate the third stage in response to determining that the fire or thermal event has spread between subpacks of at least one of the packs after performing the second stage of fire suppression.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a schematic diagram of a battery system, according to an exemplary embodiment.

FIG. 2 is a block diagram of a control system for the battery system of FIG. 1, according to an exemplary embodiment.

FIG. 3 is a left side view of a vehicle utilizing the battery system of FIG. 1, according to an exemplary embodiment.

FIG. 4 is a perspective view of a containerized energy storage system including the battery system of FIG. 1, according to an exemplary embodiment.

FIG. 5 is a diagram of a fire suppression system configured to provide fire suppressant to different coverage areas or levels of the battery system of FIG. 1, according to an exemplary embodiment.

FIG. 6 is a diagram of a control system for the fire suppression system of FIG. 5, according to an exemplary embodiment.

FIG. 7 is a flow diagram of a process for operating the control system of FIG. 6 to provide multiple stages of fire suppression, according to an exemplary embodiment.

FIG. 8 is a diagram showing a reserve supply for manual activation prior to physically opening the containerized energy storage system of FIG. 4, or the battery pack of the vehicle of FIG. 3, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, systems and methods for providing multi-stage fire suppression to a battery container are shown. The multi-stages of fire suppression can be performed discretely or at least partially concurrently with each other. The multi-stages of fire suppression can be initiated responsive to detecting a thermal event, a fire condition, a fire, smoke, off-gas emission, thermal runaway, etc., at any battery cells of the battery container. In some embodiments, initial stages locally provide fire suppressant to a location where the thermal event, fire condition, fire, smoke, etc., is detected, in order to limit further spread of the thermal event, and also to conserve the use of fire suppressant. If initial stages are unsuccessful in suppressing the fire or thermal event, subsequent stages of fire suppression can be performed that supply fire suppressant globally or more globally (e.g., over a wider coverage area) to the battery container.

### System Overview

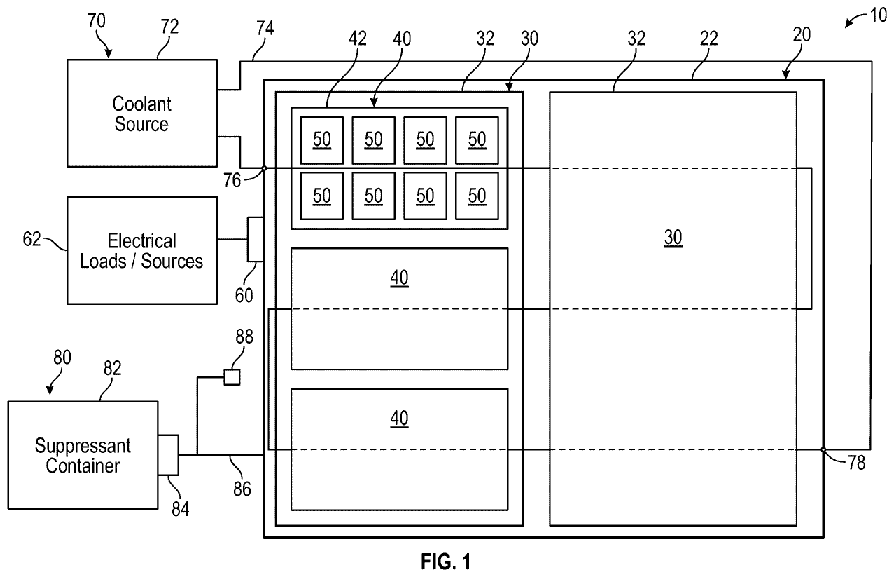

Referring to FIG. 1, a power system or battery system, shown as system 10, includes an energy storage device, energy storage assembly, battery assembly, power source, or electrical energy source, shown as battery pack 20, according to an exemplary embodiment. The battery pack 20 is configured to store energy (e.g., chemically) and later discharge the stored energy as electrical energy to power one or more electrical loads (e.g., electric motors, resistive elements, lights, speakers, etc.). In some embodiments, the battery pack 20 is rechargeable using electrical energy (e.g., from an electrical grid, from a fuel cell, from a solar panel, from an electrical motor being driven as a generator, etc.).

The battery pack 20 includes a shell or housing, shown as pack housing 22, that defines a volume containing components of the battery pack 20 (e.g., the subpacks 30). The pack housing 22 may seal the components of the battery pack 20 from the surrounding environment (e.g., limiting or preventing ingress of water or dust). The pack housing 22 may define one or more ports to facilitate transfer of electrical energy, coolant, fire suppressant, or other material into or out of the battery pack 20.

The battery pack 20 includes a series of battery portions or sections, shown as subpacks 30. By way of example, the battery pack 20 may include four subpacks 30. In other embodiments, the battery pack 20 includes more or fewer subpacks 30. Each subpack 30 is configured to store a portion of the stored energy of the battery pack 20. Each subpack 30 includes a housing 32 containing components of the subpack 30 (e.g., the battery modules 40).

Each subpack 30 includes a series of battery portions or sections, shown as battery modules 40. By way of example, each subpack 30 may include eight battery modules 40. In other embodiments, each subpack 30 includes more or fewer battery modules 40. Each battery module 40 is configured to store a portion of the stored energy of the corresponding subpack 30. Each battery module 40 includes a housing 42 containing components of the battery module 40 (e.g., the battery cells 50).

Each battery module 40 includes a series of battery portions or sections, shown as battery cells 50. By way of example, each battery module 40 may include hundreds of battery cells 50. In other embodiments, each battery module 40 includes more or fewer battery cells 50. Each battery cell 50 is configured to store a portion of the energy stored by the corresponding battery module 40.

In some embodiments, the battery cells 50 are lithium-ion (i.e., Li-ion) battery cells. Each battery cell 50 may be configured to receive electrical energy, store the received energy chemically, and release the stored electrical energy. As shown in FIG. 1, the battery cells 50 are arranged in rows adjacent one another within the battery module 40, reducing empty space within the battery module 40 and reducing the overall size of the battery pack 20. The battery cells 50 may be cylindrical cells, prismatic cells, pouch cells, or another form factor of battery cells.

The battery cells 50 may be electrically coupled to one another within the battery pack 20. By way of example, in one arrangement (a) the battery cells 50 within each battery module 40 are electrically coupled to one another, (b) the battery modules 40 within each subpack 30 are electrically coupled to one another, and (c) the subpacks 30 are electrically coupled to one another. The collective arrangement of battery cells 50, battery modules 40, and subpacks 30 is electrically coupled to a connector or port, shown as electrical port 60. The electrical port 60 electrically couples the battery cells 50 to one or more electrical sources and/or loads, shown as electrical loads/sources 62. The battery cells 50 may be discharged through the electrical port 60 to power the electrical loads/sources 62. The battery cells 50 may receive electrical energy through the electrical port 60 to charge the battery cells 50.

The battery cells 50, the battery modules 40, and the subpacks 30 may be arranged in series/parallel to control the output voltage of the battery pack 20 at the electrical port 60 and the capacity of the battery pack 20 at that output voltage. Battery cells 50 may be arranged in series with one another to increase an output voltage of the battery pack 20. Battery cells 50 may be arranged in parallel with one another to increase the capacity (e.g., measured in amp-hours) of the battery pack 20. By way of example, the battery modules 40 within each subpack 30 may be connected to one another in series, forming a string. The subpacks 30 may be connected to one another in parallel, such that the strings are connected in parallel.

In other embodiments, the battery pack 20 is otherwise arranged. By way of example, the battery pack 20 may include more or fewer battery cells 50, battery modules 40, and/or subpacks 30. By way of another example, the battery cells 50, battery modules 40, and/or subpacks 30 may be arranged in rows, columns, helical patterns, or otherwise positioned within the pack housing 22. In some embodiments, the subpacks 30 are omitted, and the battery modules 40 are positioned directly within the battery pack 20.

In some embodiments, the system 10 includes a cooling subsystem, shown as cooling system 70. The cooling system 70 includes a coolant source 72 that is configured to supply a flow of coolant to one or more conduits, shown as cooling channels 74. The coolant source 72 may include pumps, reservoirs, valves, and/or other components that facilitate handling the coolant. The coolant source 72 may also include one or more radiators or heat exchangers that facilitate discharging thermal energy from the coolant (e.g., to the surrounding atmosphere).

The cooling channels 74 pass into the pack housing 22 at an inlet 76 and exit the pack housing 22 at an outlet 78. The cooling channels 74 pass through the housings 32 of the subpacks 30 and the housings 42 of the battery modules 40 and pass adjacent (e.g., in contact with) the battery cells 50. In some embodiments, at least a portion of the cooling channels 74 is contained within and/or pass along the walls of the pack housing 22, the housings 32, and/or housings 42. The cooling channels 74 facilitate conduction between the coolant and the battery cells 50, such that thermal energy generated by the battery cells 50 (e.g., when charging or discharging electrical energy) is transferred to the coolant. The flow of coolant then transfers the thermal energy back to the coolant source 72 to be discharged. Accordingly, the cooling system 70 facilitates maintaining a consistent, low operating temperature of the battery pack 20.

Referring to FIG. 1, the system 10 further includes a fire suppression system, fire prevention system, or fire mitigation system, shown as suppression system 80. The suppression system 80 is configured to address fires within the battery pack 20 by supplying a fire suppressant. The suppressant may suppress active fires (e.g., preventing the fire from accessing oxygen). The suppressant may also cool the battery cells 50, preventing later ignition or reignition of the battery cells. The suppression system 80 may advantageously prevent, address, or otherwise mitigate thermal runaway of the battery cells 50.

The suppression system 80 includes a container of suppressant (e.g., a tank, a vessel, a cartridge, a reservoir, etc.) or fire suppressant source, shown as suppressant container 82. The suppressant may be held at an elevated pressure to facilitate dispensing the suppressant. The suppressant may include a gas (e.g., an inert gas, nitrogen, etc.), a liquid suppressant (e.g., water), a gel suppressant, a dry chemical suppressant, another type of suppressant, or combinations thereof.

The suppression system 80 further includes an actuator, shown as activator 84, that is configured to initiate a transfer (e.g., a flow) of fire suppressant from the suppressant container 82 to the battery pack 20. By way of example, the activator 84 may include a valve or seal puncture actuator that selectively permits suppressant to flow out of the suppressant container 82. By way of another example, the activator 84 may include a pump that is configured to impel the flow of suppressant.

The suppression system 80 further includes one or more conduits (e.g., pipes, hoses, tubes, etc.), shown as distribution network 86, that is configured to transfer suppressant from the suppressant container 82 to the battery pack 20. The distribution network 86 may transfer the suppressant to the interior of the battery pack 20 (e.g., inside the pack housing 22, inside the housing 32, inside the housing 42, etc.). Additionally or alternatively, the distribution network 86 may transfer the suppressant to the exterior of the battery pack 20. By way of example, the distribution network 86 may provide the suppressant to an outlet, shown as nozzle 88, that is positioned to direct suppressant to the exterior of the pack housing 22.

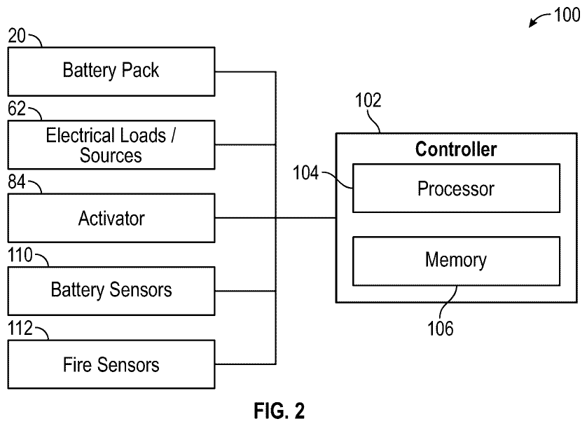

Referring to FIG. 2, a control system 100 of the system 10 is shown according to an exemplary embodiment. The control system 100 includes a processing circuit, shown as controller 102, including a processor 104 and a memory 106. The processor 104 may execute one or more instructions stored within the memory 106 to perform any of the functions described herein.

As shown, the controller 102 is operatively coupled to the battery pack 20, the electrical loads/sources 62, and the activator 84. The controller 102 may be configured to control operation of the battery pack 20 (e.g., as a battery management system), the electrical loads/sources 62, the suppression system 80, or any other component of the system 10. By way of example, the controller 102 may control charging and/or discharging of the battery pack 20. By way of another example, the controller 102 may control activation of the suppression system 80 to address one or more fires.

The control system 100 further includes one or more sensors, shown as battery sensors 110, operatively coupled to the controller 102. The battery sensors 110 may be configured to provide sensor data measuring one or more parameters related to the performance of the battery pack 20. By way of example, the battery sensors 110 may measure a current, voltage, and/or charge level within the battery pack 20. The battery sensors 110 may measure performance at the battery cell 50 level, the battery module 40 level, the subpack 30 level, and/or the battery pack 20 level. In some embodiments, the controller 102 is configured to use information from the battery sensors 110 to detect or predict a thermal event (e.g., a fire) associated with the battery pack 20. By way of example, the controller 102 may identify a change in measured current, voltage, or charge level that is indicative of a fire.

The control system 100 further includes one or more sensors, shown as thermal event sensors 112, configured to detect or predict a thermal event (e.g., a fire) associated with the battery pack 20. By way of example, the thermal event sensors 112 may include temperature sensors configured to detect an increase in temperature (e.g., of one of the battery cells 50) associated with a fire or a prediction of a fire. By way of another example, the thermal event sensors 112 may include an aspirating smoke detector that is configured to identify the presence of smoke or a gas that is produced (e.g., offgassed) when the battery cells 50 are above the standard operating temperature range. By way of another example, the thermal event sensors 112 may include an optical sensor that detects light produced by a fire.

In response to detection or prediction of a fire, the controller 102 may activate the suppression system 80 to address (e.g., prevent or suppress) the fire. By way of example, the controller 102 may actuate the activator 84 to direct suppressant to the battery pack 20. This suppressant may enter and/or surround the battery pack 20, addressing the fire.

Although a single controller 102 is shown in FIG. 2, it should be understood that the functionality of the controller 102 may be distributed across two or more separate controllers in communication with one another. By way of example, a first controller (e.g., a battery controller) may be dedicated for the battery management (e.g., controlling power usage from the battery cells 50 and charging of the battery cells 50). A second controller (e.g., a fire system controller) may be dedicated for management of the fire suppression system 80 (e.g., control over the activator 84 and the thermal event sensors 112). The two controllers would have the ability to communicate with each other such that when the fire system controller detects a fire, the fire system controller provides a signal to the battery controller. This signal commands the battery controller to disconnect or shut down usage of the affected batteries (e.g., battery packs 20, subpacks 30, battery modules 40, and/or battery cells 50) prior to discharging the fire suppression system 80.

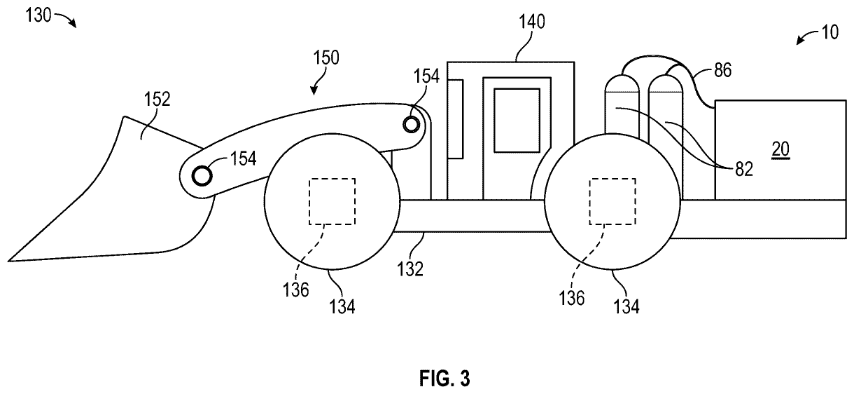

Referring to FIG. 3, a vehicle 130 is equipped with the battery system 10, according to an exemplary embodiment. As shown, the vehicle 130 is configured as a mining vehicle. Specifically, the vehicle 130 is configured as a front end loader. In other embodiments, the vehicle 130 is configured as another type of vehicle, such as a forestry vehicle, a passenger vehicle (e.g., a bus), a boat, or yet another type of vehicle.

The vehicle 130 includes a frame, shown as chassis 132, that is coupled to and supports a battery pack 20 and a pair of suppressant containers 82. The vehicle 130 includes a series of tractive elements (e.g., wheel and tire assemblies), shown as tractive elements 134, that are rotatably coupled to the chassis 132. The tractive elements 134 engage a support surface (e.g., the ground) to support the vehicle 130. The tractive elements 134 are coupled to a series of electric actuators or prime movers, shown as drive motors 136. The drive motors 136 are configured to drive the tractive elements 134 to propel the vehicle 130. In some embodiments, the drive motors 136 are electrically coupled to the battery pack 20. The drive motors 136 may consume electrical energy from the battery pack 20 (e.g., when propelling the vehicle 130) and/or provide electrical energy to charge the battery pack 20 (e.g., when performing regenerative braking).

The vehicle 130 further includes an operator compartment or cabin, shown as cab 140, that is coupled to the chassis 132. The cab 140 may be configured to contain one or more operators of the vehicle 130. The cab 140 may include one or more user interface elements (e.g., steering wheels, pedals, shifters, switches, knobs, dials, screens, indicators, etc.) that facilitate operation of the vehicle 130 by an operator.

The vehicle 130 further includes an implement assembly 150 coupled to the chassis 132. As shown, the implement assembly 150 includes an implement, shown as bucket 152. The implement assembly 150 further includes one or more actuators (e.g., electric motors, electric linear actuators, etc.), shown as implement actuators 154, that are configured to cause movement of the bucket 152 relative to the chassis 132. The implement actuators 154 may be electrically coupled to the battery pack 20. The implement actuators 154 may consume electrical energy from the battery pack 20 (e.g., when moving the bucket 152) and/or provide electrical energy to charge the battery pack 20 (e.g., when slowing the movement of the bucket 152).

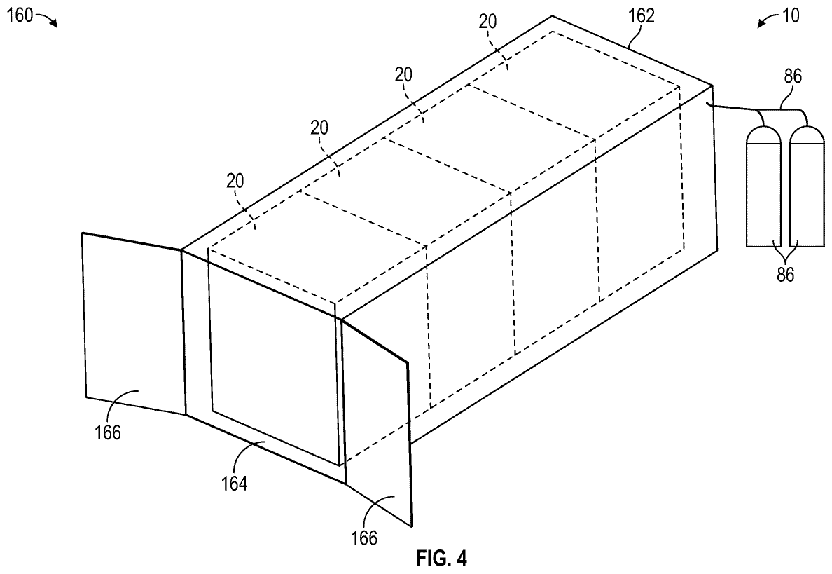

Referring to FIG. 4, a containerized energy storage system, shown as container system 160, is equipped with the battery system 10, according to an exemplary embodiment. In some embodiments, the container system 160 is configured to store energy to power one or more external electrical loads. The container system 160 may be portable (e.g., using a crane, using a container ship, using a semi truck, etc.).

As shown, the container system 160 includes a container, shown as shipping container 162, defining an internal volume 164. The internal volume 164 is selectively accessible from outside of the shipping container 162 through one or more doors 166. The internal volume 164 contains a series of battery packs 20 coupled to the shipping container 162. The battery packs 20 may be electrically coupled to one another, providing a large energy storage capacity.

### Multi-Stage Suppression

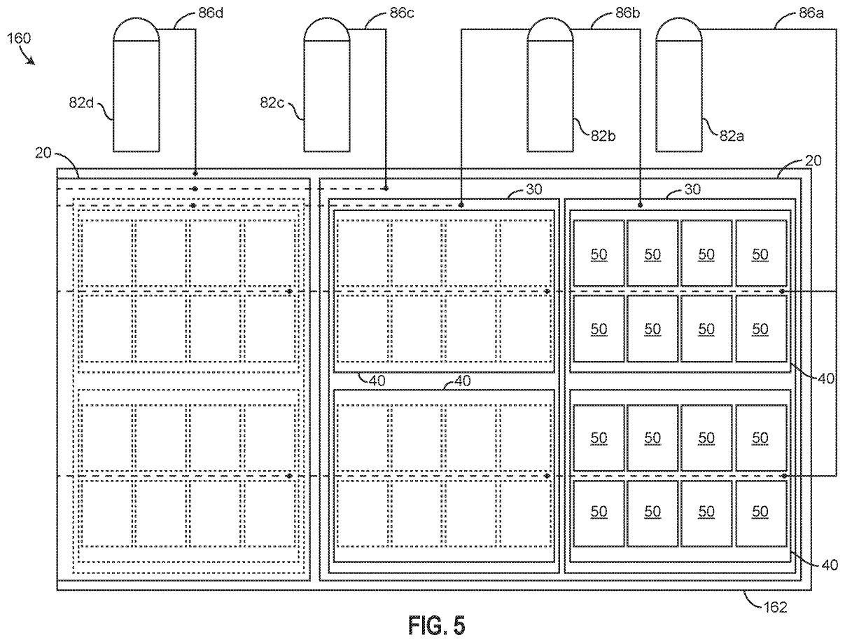

Referring to FIGS. 5-7, fire suppressant can be provided at different levels according to different stages. For example, upon detection of a fire or a thermal runaway event at a lowest level (e.g., at the battery cell 50 level), an appropriate fire suppressant container 82 may be activated to provide fire suppressant locally to the lowest level (e.g., the battery cell 50 level) where the thermal event is detected. This early detection of a thermal event results in application of a first stage agent in a localized manner. Subsequent stages may be provided with increasingly larger coverage areas (e.g., coverage volumes, coverage locations, etc.) if it is determined the prior stages of fire suppression do not suppress the thermal event or the fire.

Advantageously, early detection and release of fire suppressant in response to a thermal battery event can control the thermal event with minimal effects to other areas of, for example, the shipping container 162 that do not require fire suppression. For example, if a thermal event is detected at a particular battery module 40, the fire suppressant may be provided to that particular battery module 40, and, if such action is successful, further fire suppression may not be required. However, if this action of providing fire suppressant locally is unsuccessful and does not limit the thermal event or suppress the fire, subsequent stages with increased coverage areas may be performed in order to limit spread of the thermal event. In this way, the subsequent stages may not necessarily be required if a prior stage is able to suppress the fire or the thermal event. Subsequent stages may have more extensive hazard control and containment (e.g., a larger quantity of fire suppressant is provided, a different type of fire suppressant is provided, etc.). Advantageously, the systems and methods described herein with reference to FIGS. 5-7 may minimize damage to high value assets and be capable of providing additional fire suppression if the first stage is unsuccessful in suppressing the thermal event or the fire (e.g., due to multiple or escalating hazards, spread of the thermal event, etc.). Additionally, the systems and methods described herein may minimize damage due to false discharge, since the fire suppressant is provided in a staged or local manner (with increasing coverage area, or with different fire suppressants).

Referring to FIG. 5, the container system 160 can include a first suppressant container 82a configured to provide fire suppressant to a first level or a first coverage area, a second suppressant container 82b configured to provide fire suppressant to a second level or a second coverage area, a third suppressant container 82c configured to provide fire suppressant to a third level or a third coverage area, and a fourth suppressant container 82d configured to provide fire suppressant to a fourth level of a fourth coverage area. The first container 82a is configured to provide suppressant agent directly to the battery cells 50 at the battery module 40 level. Specifically, the first suppressant container 82a is configured to provide the suppressant agent into the housing 42 of the battery modules 40 (e.g., directly to the battery cells 50) via distribution network 86a. The second suppressant container 82b is configured to provide suppressant agent externally to the battery modules 40, at the subpack 30 level. Specifically, the second suppressant container 82b is configured to provide the suppressant agent into the housing 32 of the subpacks 30 (e.g., directly to the exterior of the battery modules 40) via distribution network 86b. The third suppressant container 82c is configured to provide suppressant agent externally to the subpacks 30 at the pack 20 level. Specifically, the third suppressant container 82c is configured to provide the suppressant agent into the housing 42 of the packs 20 (e.g., directly to the exterior of the subpacks 30) via distribution network 86c. The fourth suppressant container 82d is configured to provide suppressant agent externally to the packs 20 at the shipping container 162 level. Specifically, the fourth suppressant container 82d is configured to provide the suppressant agent into the internal volume 164 of the shipping container 162 via distribution network 86d.

In some embodiments, each of the first suppressant container 82a, the second suppressant container 82b, the third suppressant container 82c, and the fourth suppressant container 82d are configured to store and discharge a same type of fire suppressant. In some embodiments, each of the first suppressant container 82a, the second suppressant container 82b, the third suppressant container 82c, and the fourth suppressant container 82d, are configured to store and discharge equal amounts of fire suppressant. In some embodiments, the first suppressant container 82a, the second suppressant container 82b, the third suppressant container 82c, and the fourth suppressant container 82d are configured to store and discharge different types of fire suppressants, different amounts of fire suppressants, etc. It should be understood that while FIG. 5 shows each of the suppressant containers 82 being configured to provide fire suppressant to different levels of the shipping container 162, all of the suppressant containers 82 can be configured to provide the fire suppressant to a same level (e.g., locally or globally). In such an embodiment where the suppressant containers 82 provide fire suppressant at the same level (e.g., for the same coverage area), the multiple stages may differ in that different ones of the suppressant containers 82 are activated to provide different types of fire suppressants, different amounts of the same fire suppressants, different amounts of different fire suppressants, etc.

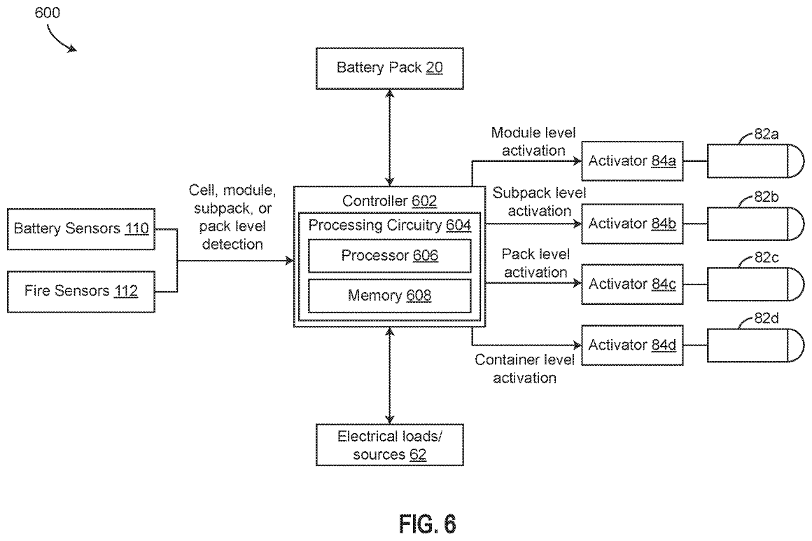

Referring to FIG. 6, a multi-stage control system 600 for the shipping container 162 includes a controller 602, the battery sensors 110, the fire sensors 112, the battery pack 20, the electrical loads/sources 62, a first activator 84a, a second activator 84b, a third activator 84c, and a fourth activator 84d. The first activator 84a is operably coupled with the first suppressant container 82a so that operation of the first activator 84a results in the first suppressant container 82a discharging its fire suppressant. The second activator 84b is similarly operably coupled with the second container 82b, the third activator 84c is similarly operably coupled with the third suppressant container 82c, and the fourth activator 84d is similarly operably coupled with the fourth suppressant container 82d.

The controller 602 includes processing circuitry 604, a processor 606, and memory 608. Processing circuitry 604 can be communicably connected to a communications interface such that processing circuitry 604 and the various components thereof can send and receive data via the communications interface. Processor 606 can be implemented as a general purpose processor, an application specific integrated circuit (ASIC), one or more field programmable gate arrays (FPGAs), a group of processing components, or other suitable electronic processing components.

Memory 608 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 608 can be or include volatile memory or non-volatile memory. Memory 608 can include database components, object code components, script components, or any other type of information structure for supporting the various activities and information structures described in the present application. According to some embodiments, memory 608 is communicably connected to processor 606 via processing circuitry 604 and includes computer code for executing (e.g., by processing circuitry 604 and/or processor 606) one or more processes described herein.

In some embodiments, controller 602 is implemented within a single computer (e.g., one server, one housing, etc.). In various other embodiments controller 602 can be distributed across multiple servers or computers (e.g., that can exist in distributed locations).

The controller 602 is configured to obtain data from the battery sensors 110 and/or the fire sensors 112 indicating cell, module, subpack, or pack level detection of a fire event, or a thermal event. In particular, the controller 602 can detect a fire, a thermal event, a change in temperature, a rate in change of temperature, etc., at any of the battery cells 50 of the shipping container 162, at any of the modules 40 of the shipping container 162, at any of the subpacks 30 of the shipping container 162, or at any of the packs 20 of the shipping container 162. The controller 602 can also use smoke detection, electrolyte or off-gas detection, etc., to detect a thermal event at any of the cell, module, subpack, or pack level.

In response to detecting a thermal event or a fire at the cell level (e.g., detecting a thermal event or a condition at one or more of the battery cells 50), the controller 602 can provide module level activation to the activator 84a so that the first suppressant container 82a operates to discharge fire suppressant to one or more of the modules 40 of the shipping container 162 where the thermal event is detected (e.g., to provide fire suppressant to an interior of the module 40 which contains the battery cells 50 at which the thermal event is detected). In this way, the first stage may be operated to provide module-level fire suppression in response to cell-level detection of a thermal event. Providing module-level fire suppression can reduce a likelihood of the thermal event or fire at the battery cell 50 spreading to other battery cells 50 in the module 40. In some embodiments, the first stage includes sequentially providing suppressant into different zones of the modules 40 before beginning the second stage. For example, the subpacks 30 or the packs 20 may be divided into different zones, and a stage of suppression may include sequentially providing suppressant into the different zones before transitioning into the next stage.

In response to detecting a thermal event or a fire at the module level (e.g., if one of the battery cells 50 causes a significant portion of other battery cells 50 within the module 40 to also catch fire or undergo a thermal event), the controller 602 is configured to operate the activator 84b (e.g., by providing subpack level activation to the activator 84b) so that the second suppressant container 82b operates to discharge fire suppressant into one or more of the subpacks 30 where the thermal event is detected (e.g., to provide fire suppressant to an interior of the subpack 30 which contains the module(s) 40 at which the thermal event is detected). In this way, the second stage may be performed to provide subpack-level fire suppression in response to module-level detection of a thermal event. Providing subpack-level fire suppression can reduce a likelihood of the thermal event or fire at the modules 40 from spreading to other modules in the subpack 30.

In response to detecting a thermal event or a fire at the subpack level (e.g., if one or more of the subpacks 30 are undergoing a thermal event or have caught fire), the controller 602 is configured to operate the activator 84c (e.g., by providing pack level activation to the activator 84c) so that the third suppressant container 82c operates to discharge fire suppressant into one or more of the packs 20 where the thermal event is detected (e.g., to provide fire suppressant to an interior of the pack 20 which contains the subpacks 30 at which the thermal event is detected). In this way, the third stage may be performed to provide pack-level fire suppression in response to sub-pack level detection of a thermal event. Providing pack-level fire suppression can reduce a likelihood of the thermal event or fire at the subpacks 30 from spreading to other modules in the pack 20.

In response to detecting a thermal event or a fire at the pack level (e.g., if one or more of the packs 20 are undergoing a thermal event or have caught fire), the controller 602 is configured to operate the activator 84d (e.g., by providing container level activation to the activator 84d) so that the fourth suppressant container 82d operates to discharge fire suppressant into the shipping container 162 where the thermal event is detected (e.g., to provide fire suppressant to an interior of the shipping container 162 which contains the packs 20 at which the thermal event is detected). In this way, the fourth stage may be performed to provide container-level fire suppression in response to pack-level detection of a thermal event. Providing container-level fire suppression may be the highest level stage that provides fire suppressant to an entire interior of the shipping container 162 to suppress any fires or thermal events within the shipping container 162 and to limit the shipping container 162 from catching fire.

In some embodiments, the suppressant containers 82a-82d include different types of fire suppressant. For example, the first suppressant container 82a may include an inert gas to provide a first stage of fire suppression. The second suppressant container 82b may include liquid CO2 for a second stage of fire suppression. In some embodiments, the first suppressant container 82a and the second suppressant container 82b are both configured to provide fire suppressant to a same coverage area, but provide different fire suppressants. For example, inert gas can be provided in the first stage, and liquid CO2 can be provided in the second stage. If the thermal event is still occurring, or has spread, then a third stage of fire suppression may be performed by the controller 602 over a larger coverage area. In some embodiments, the different stages are performed to provide an initial fire suppression, and to also provide a longer term cooling.

In some embodiments, one or more of the stages described herein are optional. For example, the first suppressant tank 82a and the first stage may be optional. In some embodiments, any of the stages described herein include sub-stages. For example, the first stage may include a first sub-stage in which inert gas is provided to the interior of one or more modules 40, to provide initial fire suppression of the battery cells 50, and a second sub-stage in which liquid CO2 is provided to the interior of one or more modules 40, to provide longer term cooling to limit or reduce a likelihood of reignition.

In some embodiments, the first stage includes providing fire suppression within the modules 40 (e.g., providing suppressant into the modules 40), and the second stage includes providing fire suppression outside of the modules 40 (e.g., providing suppressant into the subpacks 30 or the packs 20). In some embodiments, the first stage includes providing fire suppression using a first type of suppressant (e.g., into the modules 40) and the second stage includes providing fire suppression using a second type of suppressant (e.g., also into the modules 40).

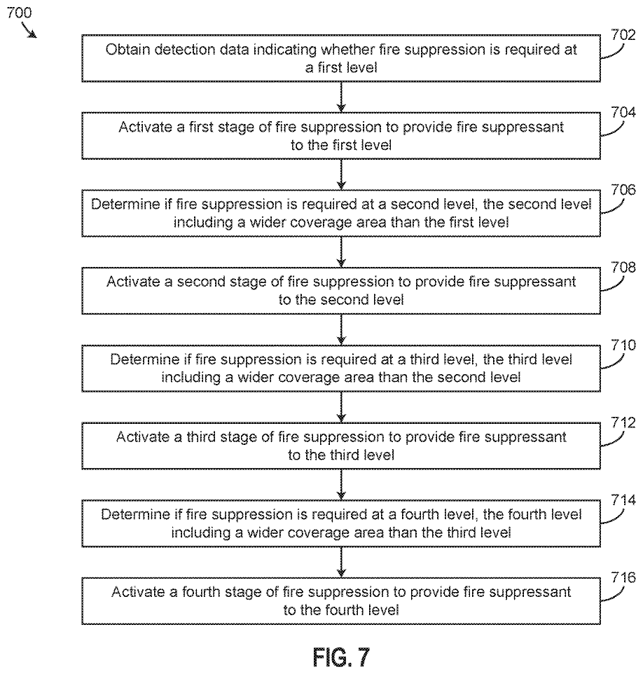

Referring to FIG. 7, a process 700 can be performed by the controller 602 to operate the various suppressant tanks 82a-82d to provide different stages of fire suppression, according to some embodiments. Process 700 illustrates a multi-stage fire suppression, where subsequent stages have wider coverage areas. It should be understood that any of the stages of fire suppression described herein with reference to FIG. 7 may include different types of fire suppressant, or may be optional. Further, any of the stages described herein with reference to FIG. 7 can have any number of sub-stages in which different types or different quantities of fire suppressant are provided to the same coverage area. In some embodiments, any of the sub-stages can be performed at least partially concurrently or simultaneously with each other.

Process 700 includes obtaining detection data indicating whether fire suppression is required at a first level (step 702), according to some embodiments. Step 702 can be performed by the controller 602 based on any data obtained from the electrical loads/sources 62, the battery pack 20, the battery sensors 110, the fire sensors 112, etc., of the multi-stage control system 600. If the detection data indicates that a thermal event or a fire has occurred at the first level (e.g., at the battery cells 50), process 700 proceeds to step 704.

Process 700 includes activating a first stage of fire suppression to provide fire suppressant to the first level (step 704), according to some embodiments. In some embodiments, step 704 includes generating and providing activation signals for the first activator 84a so that the first suppressant container 82a discharges fire suppressant to the first level where the thermal event or fire is detected (e.g., into the modules 40 where the fire or thermal event is detected at the battery cells 50). In some embodiments, step 704 is performed by the controller 602.

Process 700 includes determining if fire suppression is required at a second level, the second level including a wider coverage area than the first level (step 706), and activating a second stage of fire suppression to provide fire suppressant to the second level (step 708), according to some embodiments. Process 700 also includes determining if fire suppression is required at a third level, the third level including a wider coverage area than the second level (step 710) and activating a third stage of fire suppression to provide fire suppressant to the third level (step 712), according to some embodiments. Process 700 also includes determining if fire suppression is required at a fourth level, the fourth level including a wider coverage area than the third level (step 714), and activating a fourth stage of fire suppression to provide fire suppressant to the fourth level (step 716), according to some embodiments. In some embodiments, steps 706, 710, and 714 are similar but are performed to determine if the fire or thermal event has spread to a higher level, and accordingly, if a next stage of fire suppression is required.

It should be understood that the systems and methods described herein with reference to FIGS. 5-7 may also be applicable to the vehicle 130. In such an embodiment, the fourth stage (e.g., the fourth suppressant container 82d) is not necessarily used, unless the battery pack 20 is positioned within a container or bay of the vehicle 130, in which case the container or bay of the vehicle 130 may be treated as the shipping container 162.

### Reserve Supply Stage

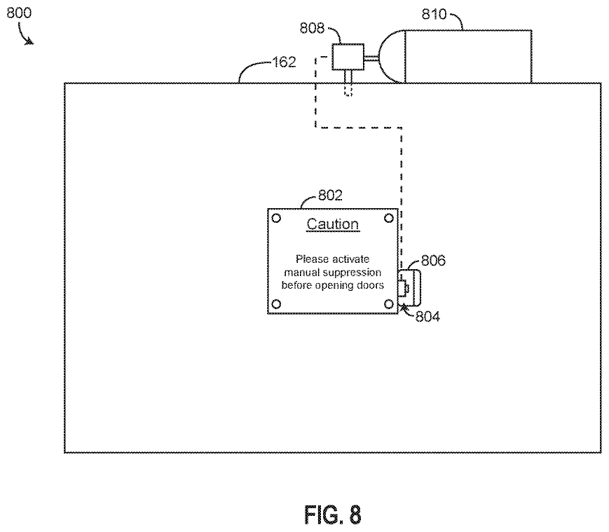

Referring to FIG. 8, the shipping container 162 or the battery pack 20 (e.g., when implemented on the vehicle 130) may include a reserve supply system 800 for manual discharge of a reserve supply prior to physically opening the shipping container 162 or the battery pack 20. The reserve supply system 800 includes a sign 802 (e.g., a physical sign, a plaque, a message, a board, etc.), a suppressant container 810, an activator 808, and a manual activation switch 804. The manual activation switch 804 can be positioned within a box 806 (e.g., a lock box, a container, etc.) to protect the manual activation switch 804 from accidental or unintentional activation. The container 810 can be configured to store a fire suppressant such as liquid CO2, and is configured to deliver the fire suppressant into the shipping container 162 or the battery pack 20 to provide additional cooling or fire suppression. In some embodiments, the liquid CO2 may evaporate once introduced to the shipping container 162 or the battery pack 20, causing the battery cells 50 to cool or even freeze.

When first responders (e.g., firefighters) arrive to the scene of the shipping container 162 or the battery pack 20, it may be desirable to provide an additional or reserve supply of fire suppressant immediately prior to physically opening the shipping container 162 or the battery pack 20. In some embodiments, the sign 802 includes a message instructing the first responders to manually activate the reserve supply system 800 prior to physically opening the shipping container 162 or the battery pack 20. If a thermal event has occurred, gases and heat may build up in the shipping container 162 or the battery pack 20 over time, and physically opening the shipping container 162 or the battery pack 20 without first providing the reserve supply of fire suppressant may introduce oxygen to the interior of the shipping container 162 or the battery pack 20, which can cause an additional thermal runaway or fire event (e.g., smoke, flames, deflagration event, explosion, combustion, etc.).

When the first responders arrive, the first responders may operate the manual activation switch 804, which is operably or electrically coupled with the activator 808 of the suppressant container 810. Once operated, the manual activation switch 804 sends a signal or command to the activator 808 so that the reserve capacity of fire suppressant stored in the suppressant container 810 (e.g., a reserve capacity container) is introduced into the shipping container 162 or the battery pack 20, thereby flooding the interior of the shipping container 162 or the battery pack 20, and reducing a likelihood of a fire event when physically opening the shipping container 162 or battery pack 20. The activator 808 can be the same as or similar to any of the activators 84, and the suppressant container 810 can be the same as or similar to any of the suppressant containers 82 as described in greater detail above.

In some embodiments, flooding the interior of the shipping container 162 or the battery pack 20 with the reserve supply or capacity of fire suppressant stored in the suppressant container 810 is performed as an additional stage or step of process 700 that is manually initiated.

### Configuration of the Exemplary Embodiments

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system 10 as shown in the various exemplary embodiments is illustrative only. Additionally, any element disclosed in one embodiment may be incorporated or utilized with any other embodiment disclosed herein. For example, the arrangement of multiple battery packs 20 of the exemplary embodiment shown in at least FIG. 4 may be incorporated in the vehicle 130 of the exemplary embodiment shown in at least FIG. 3. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A container system comprising:
a shipping container comprising a plurality of battery cells; and
a fire suppression system comprising:
a plurality of fire suppressant containers, each configured to store fire suppressant and discharge the fire suppressant to a coverage area of the shipping container; and
processing circuitry configured to:
obtain detection data indicating a detection of a thermal event or a fire within the shipping container;
in response to the detection of the thermal event or the fire within the shipping container, sequentially activating the plurality of fire suppressant containers to provide fire suppression according to a plurality of stages of fire suppression.

2. The container system of claim 1, wherein the plurality of stages each include providing the fire suppressant to a different coverage area, wherein prior stages of the plurality of stages of fire suppression comprise providing fire suppressant to a smaller coverage area, and following stages of the plurality of stages of fire suppression comprise providing fire suppressant to a larger coverage area.

3. The container system of claim 1, wherein one or more of the plurality of stages comprise providing a different type of fire suppressant into the shipping container, wherein at least one of the stages comprises sequentially providing fire suppression to different zones before transitioning to a next of the plurality of stages.

4. The container system of claim 1, wherein the shipping container comprises a plurality of packs, each pack of the plurality of packs comprising a plurality of subpacks positioned within the pack, each subpack of the plurality of subpacks comprising a plurality of modules positioned within the subpack, and each module of the plurality of modules comprising a subset of the plurality of battery cells positioned within the module.

5. The container system of claim 4, wherein the plurality of stages comprise at least two stages and the plurality of fire suppressant containers comprise at least two fire suppressant containers;
wherein in a first stage of fire suppression, a first of the at least two fire suppressant containers is configured to provide fire suppressant into at least one of the plurality of modules to suppress a fire at one or more of the plurality of battery cells;
wherein in a second stage of fire suppression, a second of the at least two fire suppressant containers is configured to provide fire suppressant into at least one of the plurality of subpacks to suppress a fire at one or more of the plurality of modules;
wherein the processing circuitry is configured to activate the second stage of fire suppression in response to determining that the fire or thermal event has spread between modules of at least one of the plurality of subpacks after performing the first stage of fire suppression.

6. The container system of claim 5, wherein the plurality of stages comprises a third stage of fire suppression and the plurality of fire suppressant containers comprise a third fire suppressant container;
wherein in the third stage of fire suppression, the third of the plurality of fire suppressant containers is configured to provide fire suppressant into the plurality of packs to suppress a fire or thermal event at one or more of the plurality of subpacks;
wherein the processing circuitry is configured to activate the third stage in response to determining that the fire or thermal event has spread between subpacks of at least one of the plurality of packs after performing the second stage of fire suppression.

7. The container system of claim 6, wherein the plurality of stages comprises a fourth stage and the plurality of fire suppressant containers comprise a fourth fire suppressant container;
wherein in the fourth stage, the fourth of the plurality of fire suppressant containers is configured to provide fire suppressant into the shipping container outside of the plurality of packs to suppress a fire or thermal event at one or more of the plurality of packs;
wherein the processing circuitry is configured to activate the fourth stage in response to determining that the fire or thermal event has spread between packs after performing the third stage of fire suppression.

8. A vehicle comprising:
a pack comprising a plurality of battery cells; and
a fire suppression system comprising:
a plurality of fire suppressant containers, each configured to store fire suppressant and discharge the fire suppressant to a coverage area of the pack; and
processing circuitry configured to:
obtain detection data indicating a detection of a thermal event or a fire within the pack;
in response to the detection of the thermal event or the fire within the pack, sequentially activating the plurality of fire suppressant containers to provide fire suppression according to a plurality of stages of fire suppression.

9. The vehicle of claim 8, wherein the plurality of stages each include providing the fire suppressant to a different coverage area, wherein prior stages of the plurality of stages of fire suppression comprise providing fire suppressant to a smaller coverage area, and following stages of the plurality of stages of fire suppression comprise providing fire suppressant to a larger coverage area.

10. The vehicle of claim 8, wherein one or more of the plurality of stages comprise providing a different type of fire suppressant into the pack.

11. The vehicle of claim 8, wherein the pack comprises a plurality of subpacks positioned within the pack, each subpack of the plurality of subpacks comprising a plurality of modules positioned within the subpack, and each module of the plurality of modules comprising a plurality of the battery cells positioned within the module.

12. The vehicle of claim 11, wherein the plurality of stages comprise at least two stages and the plurality of fire suppressant containers comprise at least two fire suppressant containers;
wherein in a first stage of fire suppression, a first of the at least two fire suppressant containers is configured to provide fire suppressant into at least one of the plurality of modules to suppress a fire at one or more of the plurality of battery cells;
wherein in a second stage of fire suppression, a second of the at least two fire suppressant containers is configured to provide fire suppressant into at least one of the plurality of subpacks to suppress a fire at one or more of the plurality of modules;
wherein the processing circuitry is configured to activate the second stage of fire suppression in response to determining that the fire or thermal event has spread between modules of at least one of the plurality of subpacks after performing the first stage of fire suppression.

13. The vehicle of claim 12, wherein the plurality of stages comprises a third stage and the plurality of fire suppressant containers comprise a third fire suppressant container;
wherein in the third stage, the third of the plurality of fire suppressant containers is configured to provide fire suppressant into the pack to suppress a fire or thermal event at one or more of the plurality of subpacks;
wherein the processing circuitry is configured to activate the third stage in response to determining that the fire or thermal event has spread between subpacks of at least one of a plurality of packs after performing the second stage of fire suppression.

14. The vehicle of claim 8, wherein the vehicle is a mining vehicle comprising a plurality of tractive elements and an implement assembly, the implement assembly and the plurality of tractive elements driven by one or more electric motors configured to consume electrical energy from the plurality of battery cells of the pack.

15. A container system comprising:
a shipping container comprising a plurality of battery cells; and
a fire suppression system comprising:
a plurality of fire suppressant containers, each configured to store fire suppressant and discharge the fire suppressant to a coverage area of the shipping container;
a reserve supply suppression system separate from the fire suppression system, the reserve supply suppression system comprising:
a reserve suppressant container configured to be manually activated to discharge a reserve supply of fire suppressant into the shipping container immediately prior to physically opening the shipping container to reduce a likelihood of a fire event occurring in response to physically opening the shipping container.

16. The container system of claim 15, further comprising processing circuitry configured to:
obtain detection data indicating a detection of a thermal event or a fire within the shipping container;
in response to the detection of the thermal event or the fire within the shipping container, sequentially activating the plurality of fire suppressant containers to provide fire suppression according to a plurality of stages of fire suppression.

17. The container system of claim 16, wherein the plurality of stages each include providing the fire suppressant to a different coverage area, wherein prior stages of the plurality of stages of fire suppression comprise providing fire suppressant to a smaller coverage area, and following stages of the plurality of stages of fire suppression comprise providing fire suppressant to a larger coverage area.

18. The container system of claim 16, wherein one or more of the plurality of stages comprise providing a different type of fire suppressant into the shipping container.

19. The container system of claim 17, wherein the plurality of stages comprise at least two stages and the plurality of fire suppressant containers comprise at least two fire suppressant containers;
wherein in a first stage of fire suppression, a first of the at least two fire suppressant containers is configured to provide fire suppressant into at least one of a plurality of modules to suppress a fire at one or more of the plurality of battery cells;
wherein in a second stage, a second of the at least two fire suppressant containers is configured to provide fire suppressant into at least one of a plurality of subpacks to suppress a fire at one or more of the plurality of modules;
wherein the processing circuitry is configured to activate the second stage in response to determining that the fire or thermal event has spread between modules of at least one of the plurality of subpacks after performing the first stage of fire suppression.

20. The container system of claim 19, wherein the plurality of stages comprises a third stage and the plurality of fire suppressant containers comprise a third fire suppressant container;
wherein in the third stage, the third of the plurality of fire suppressant containers is configured to provide fire suppressant into a plurality of packs to suppress a fire or thermal event at one or more of the plurality of subpacks;
wherein the processing circuitry is configured to activate the third stage in response to determining that the fire or thermal event has spread between subpacks of at least one of the plurality of packs after performing the second stage of fire suppression.
